(19) United States
(12) Patent Application Publication
(10) Pub. No.: US 2012/0194144 A1
(43) Pub. Date: Aug. 2, 2012

(54) BALANCING THREE PHASE POWER SYSTEMS BY SMOOTH PAHSE SHIFTING AND CLUSTERING

(76) Inventors: Erez KOREN, Givatayim (IL); Michael VYSOTSKY, Karmiel (IL); Alexander GUSINSKY, Karmiel (IL)

(21) Appl. No.: 13/358,807

(22) Filed: Jan. 26, 2012

Related U.S. Application Data
(60) Provisional application No. 61/437,640, filed on Jan. 30, 2011.

(51) Int. Cl. G05F 1/00

(52) U.S. Cl. 323/212

(57) ABSTRACT

A method of maintaining balance in power systems is provided herein. The method comprises of detecting a need for load switch from a source phase to a target phase; then applying a Direct Current (DC) conversion to the target phase, to yield a DC representation of the target phase; then synthesizing the DC representation of the target phase to yield synthesized source phase; then, conveying specified amount of load from the source phase to the synthesized source phase; then, repeatedly advancing, in each cycle, the phase of the synthesized source phase until it breaches the phase of target phase. The advancing is carried out in a rate of up to a standard error deviation that complies with electricity standard and conveying a load from the synthesized source phase to the target phase.

### BACKGROUND

1. Technical Field

The present invention relates to the field of balancing three phase electric power source systems, and more particularly, to detection of imbalance in a three phase electric power source system and return of balance to the system by smooth phase shifting and redistribution of load.

2. Discussion of Related Art

Prior to setting forth the background of the related art, it may be helpful to set forth definitions of certain terms that will be used hereinafter.

The term “real power” as used herein in this application, is defined as the capacity of the circuit for performing work in a particular time.

The term “apparent power” as used herein in this application, is defined as the product of the current and voltage of the circuit.

A three-phase power system is called balanced or symmetrical if the three-phase voltages and currents have the same amplitude and are phase shifted by 120° with respect to one another. If either or both of these conditions are not met, the system is called unbalanced or asymmetrical and a correction might be sought.

Unbalance is a common occurrence in three-phase electrical distribution systems. However, it can be harmful to the operation of the network, its reliability and safety. Furthermore, measurements show that real power losses increase due to unbalanced loads. One of the main causes for unbalance in electrical distribution networks , both in three-wire and four-wire systems, is the fact that loads are switched on and off by end users.

An abrupt correction of phase in an electric power system may damage electric devices that are connected to that system. Moreover, phase deviation may decrease efficiency of the electric power system. Therefore, several solutions for phase balancing exist in the market.

Prior art Patent No. GB 1162663 REACTIVE CURRENT CONVERTER FOR BALANCING THE LOAD IN A THREE-PHASE ELECTRICAL SUPPLY NETWORK provides a force-commutated converter for balancing the load of three-phase mains and correcting electric power factor utilizes reverse-current rectifiers and is connected to the load without series chokes.

Low voltage loads are usually single-phase, e.g. PCs or lighting systems, and the balance between phases is therefore difficult to guarantee. In the layout of an electrical wiring system feeding these loads, the load circuits are distributed amongst the three-phase systems, for instance one phase per floor of an apartment or office building or alternating connections in rows of houses. Still, the balance of the equivalent load at the central transformer fluctuates because of the statistical spread of the duty cycles of the different individual loads.

Abnormal system conditions also cause phase unbalance. Phase-to-ground, phase-to-phase and open conductor faults are typical examples. These faults cause voltage dips in one or more of the phases involved and may even indirectly cause over-voltages on the other phases. The system behavior is then unbalanced by definition, but such phenomena are usually classified under voltage disturbances, which are discussed in the corresponding application guides, since the electricity grid's protection system should cut off the fault.

Unbalance is a serious power quality problem, mainly affecting low-voltage distribution systems, as for instance encountered in office buildings with abundant PCs and lighting. However, it can be quantified in a relatively simple manner resulting in parameters that can be compared to standardized values.

### BRIEF SUMMARY

Optimal balancing of a three phase distribution system requires redistribution of loads between the three phases. Nevertheless, switching a load between phases creates a change in the phase angle of the provided current. An abrupt correction of phase angle in an electric power system may damage electric devices that are connected to that system. Moreover, phase deviation itself may decrease efficiency of the electric power system. Existing art provides several solutions to overcome these cons. None of the solutions of the existing art from our knowledge are taking into account gradual transferring of electric power in such a way that it does not affect the usage of electric devices. Further, none of the existing art performs cluster division of low voltage neighborhood areas.

Embodiments of the present invention provide a method of maintaining balance in electric power systems, the method comprising: detecting a need for load switch from a source phase to a target phase; then applying a Direct Current (DC) conversion to the target phase, to yield a DC representation of the target phase;

Accordingly, according to an aspect of the present invention, there is provided synthesizing the DC representation of the target phase to yield synthesized source phase.

Accordingly, according to another aspect of the present invention, there is provided conveying specified amount of load from the source phase to the synthesized source phase.

Accordingly, according to yet another aspect of the present invention, there is provided repeatedly advancing, in each cycle, the phase angle of the synthesized source phase until it breaches the phase of target phase, wherein the advancing is carried out in a rate of up to a standard error deviation that complies with electricity standard; and conveying a load from the synthesized source phase to the target phase.

These, additional, and/or other aspects and/or advantages of the present invention are: set forth in the detailed description which follows; possibly inferable from the detailed description; and/or learnable by practice of the present invention.

### BRIEF DESCRIPTION OF THE DRAWINGS

The present invention will be more readily understood from the detailed description of embodiments thereof made in conjunction with the accompanying drawings of which:

FIG. 1 is a high level schematic block diagram of three phase load according to some embodiments of the invention;

FIG. 2 is a high level flowchart illustrating maintenance of balance in power system to some embodiments of the invention.

FIG. 3 is a high level schematic block diagram illustrating phase transfer according to some embodiments of the invention;

FIG. 4 is a high level schematic block diagram illustrating a power cluster according to some embodiments of the invention; and

FIG. 5 is a high level schematic block diagram illustrating a phase manipulation device according to some embodiments of the invention;

### DETAILED DESCRIPTION

Before explaining at least one embodiment of the invention in detail, it is to be understood that the invention is not limited in its application to the details of construction and the arrangement of the components set forth in the following description or illustrated in the drawings. The invention is applicable to other embodiments or of being practiced or carried out in various ways. Also, it is to be understood that the phraseology and terminology employed herein is for the purpose of description and should not be regarded as limiting.

For a better understanding of the invention, the usages of the following terms in the present disclosure are defined in a non-limiting manner:

The term “cluster” as used herein in this application, is defined as a group of single phase or three phase loads.

The term “phase shifting” as used herein in this application, is defined as the correction to 120° between three phases.

The term “real power” as used herein in this application, is defined as the capacity of the circuit for performing work in a particular time.

The term “apparent power” as used herein in this application, is defined as the product of the current and voltage of the circuit.

The term “power factor” as used herein in this application, is defined as the ratio of the real power flowing to the load to the apparent power in the circuit.

The term “black box” as used herein in this application, is defined as a system that may be viewed only by its input and output.

The area beyond NAN (Neighborhood area Network) transformer is considered as a black box having no load balancing capabilities. One of the most important outcomes out of phase balancing is a huge energy saving, reflected from every NAN transformer to the metropolitan area and to the country wide area that may reach half of total wasted power across the distribution lines.

A real time calculation of the consumption of each cluster and execution of required change without any power interruption has to be performed. Therefore a power cluster system is provided herein.

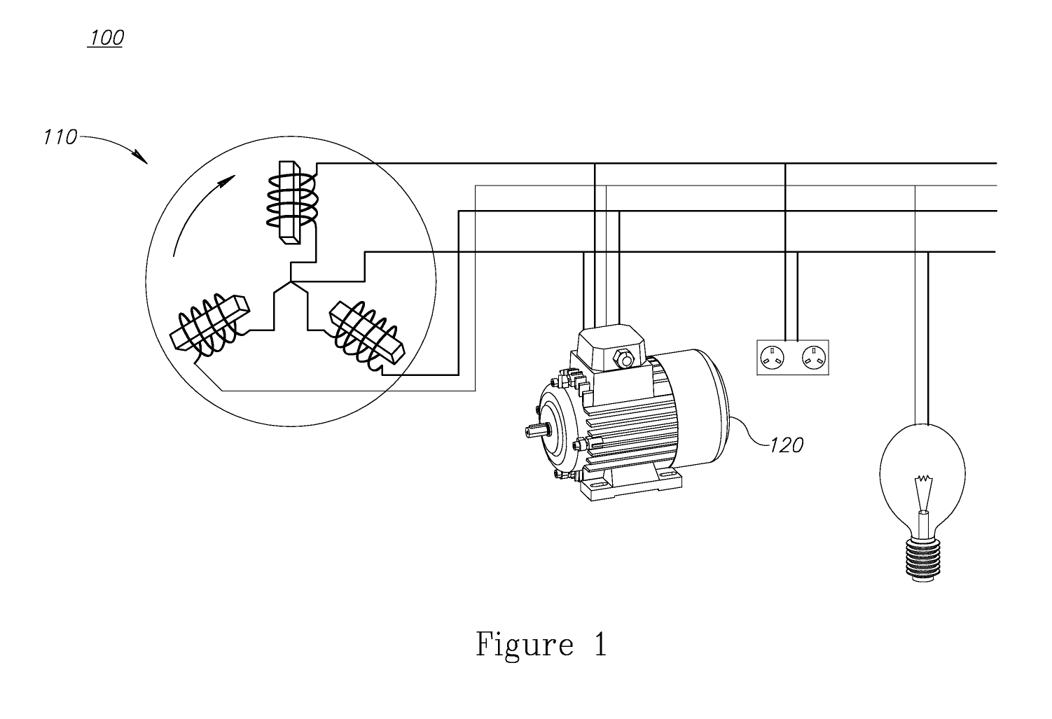

FIG. 1 is a high level schematic block diagram of three phase load according to some embodiments of the invention.

According to some embodiments of the present invention, a method to correct an imbalance of phase voltage in an electric power system is provided herein. The present invention provides balancing along with a gradual shifting of load that may result in less damage to end-user electronic devices 120 than abrupt shifting of load.

According to embodiments, as illustrated in FIG. 1, may be enhanced by some or all of the following features: a three phase 110 having 120° phase angle difference between each phase. A correction of phase to a mediator phase is advancing in a rate of up to a standard error deviation that complies with electricity standard.

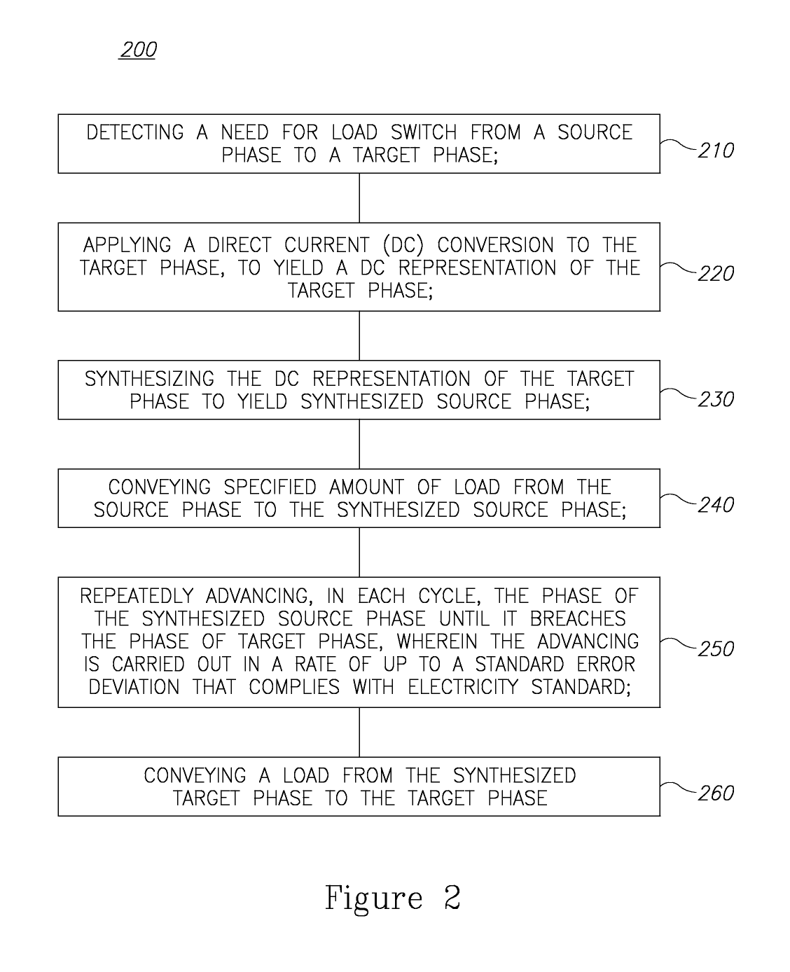

FIG. 2 is a high level flowchart illustrating maintenance of balance in power system to some embodiments of the invention.

Detecting a need for load shift from a source phase to a target phase; (210). Applying a Direct Current (DC) conversion to the target phase, to yield a DC representation of the target phase; (220). Synthesizing the DC representation of the target phase to yield synthesized source phase; (230). Conveying specified amount of load from the source phase to the synthesized source phase; (240). Repeatedly advancing, in each cycle, the phase angle of the synthesized source phase until it breaches the phase of target phase, wherein the advancing is carried out in a rate of up to a standard error deviation that complies with electricity standard; (250). Conveying a load from the synthesized source phase to the target phase. (260).

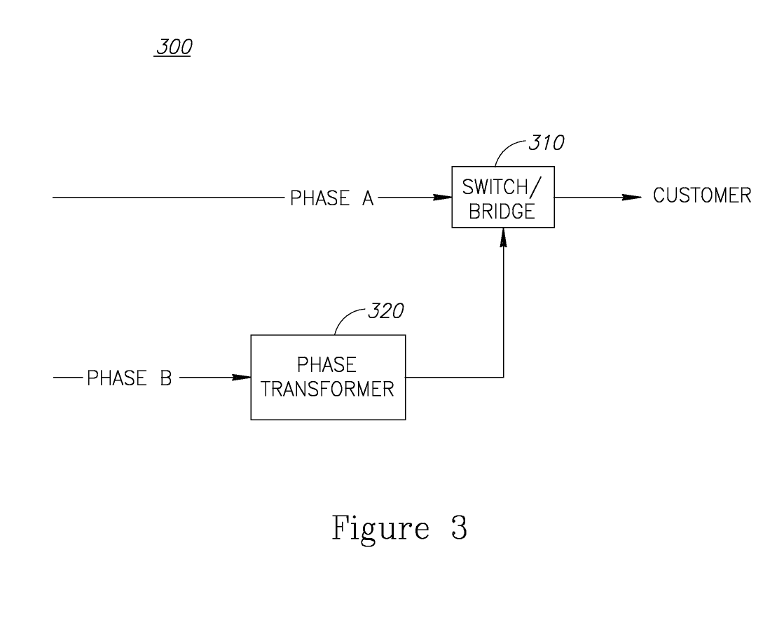

FIG. 3 is a high level schematic block diagram illustrating phase transfer according to some embodiments of the invention. The present invention provides a cluster phase balancing system consists on one or more cluster element, of which all or part of the elements have “phase alternation” 320 capabilities. Further, one or more of the elements have decision making capabilities. Information about the real time or near real time dynamic characteristics of the electrical distribution grid is obtained through interfacing with other grid elements, e.g. smart meters (AMI) and other sensors, in addition to the Cluster element measuring capabilities.

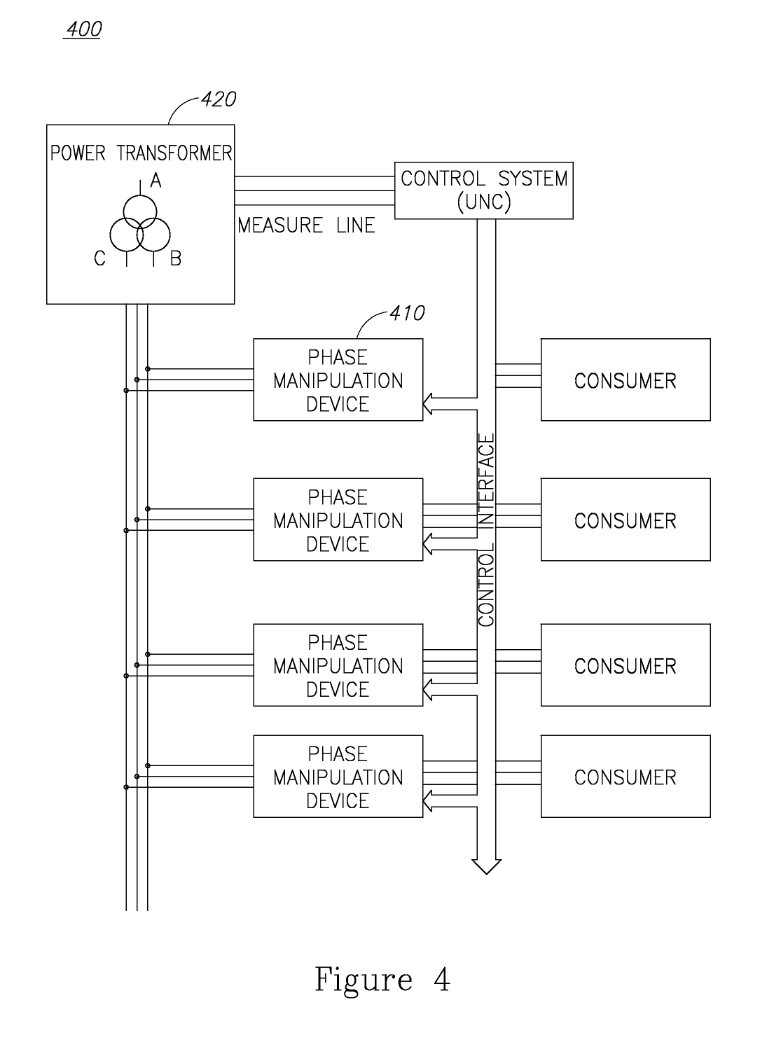

FIG. 4 is a high level schematic block diagram illustrating a power cluster according to some embodiments of the invention. The power cluster system 400 calculates power consumption in each phase, and provides the recommendation to alternate between one or more phases. In most countries electricity regulation of electric devices allows a frequency deviation of 0.1% (both in 50 Hz and 60 Hz systems), the alternation of phases is performed by reaching a 120° phase angle shift in the altered phase, a process for which approximately takes four seconds.

Shifting between phases can be done to a single load, single phase, Shifting between phases can be done to a cluster of loads, single phase Shifting between phases can be done to a single load, multiple phases at once, Shifting between phases can be done to a cluster of loads, multiple phases at once.

In case of a phase that is not balanced for single-phase consumers, balancing process provides gradual shifting phases for individual customers.

Since a phase jump may occur at the time of shifting and may lead to failure of electric devices that use transformative power supplies, a selection of optimum phase loading may result in smoothing of electric consumption and to reduction of losses due to imbalance phase. In order to shift a phase, the present invention provides a device 410 for phase alignment. Its operation is based on using the allowed frequency tolerance error 50/60±0.1 Hz.

Initially, one or all of the phases are rectified to DC and then, by the use of power electronics and a microprocessor, they are inverted to an alternating current wave with a +0.1 Hz offset from the original phase (Digital-to-Analog output). In a non limiting example, in case of a 50 Hz circuit, in one period, the present invention may provide a phase angle shift of approx. 0.2%, which corresponds to 0.72° (360/50). In order to align the altered phase a complete 120° phase angle shift, therefore 120/0.72˜=167 periods are needed or alternatively, 167×20 msec=3.34 sec. Once the phase angle shift is complete, a new load and phase connection does not require any additional transformation, and the AC/DC/AC link can be bypassed.

In another non limiting example, in case of a maximum power consumption by the consumer that does not exceed 220×40=8.8 kW, a 10 kW device should suffice. If the number of shifting will not exceed every 30 minutes, the dimensions of such a switch does not exceed 300×400×100 mm.

Therefore, the present invention may advantageously provide predefined clusters of end-user areas for power saving at peak hours. Further, a higher utilization of deployed transformers and Supply back office with critical mission data from a black box.

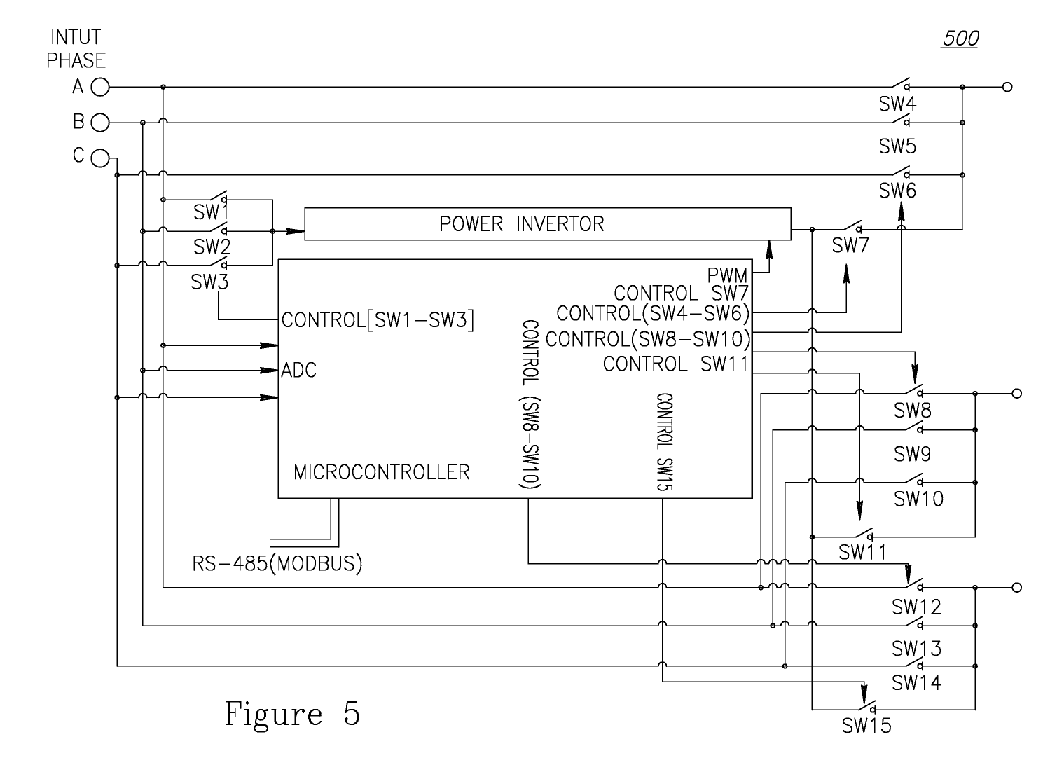

FIG. 5 is a high level schematic block diagram illustrating a phase manipulation device according to some embodiments of the invention. The phase manipulation device 500 is a non limiting example of a device for gradual shift of phases.

In the above description, an embodiment is an example or implementation of the invention. The various appearances of “one embodiment”, “an embodiment” or “some embodiments” do not necessarily all refer to the same embodiments.

Although various features of the invention may be described in the context of a single embodiment, the features may also be provided separately or in any suitable combination. Conversely, although the invention may be described herein in the context of separate embodiments for clarity, the invention may also be implemented in a single embodiment.

Furthermore, it is to be understood that the invention can be carried out or practiced in various ways and that the invention can be implemented in embodiments other than the ones outlined in the description above.

The invention is not limited to those diagrams or to the corresponding descriptions. For example, flow need not move through each illustrated box or state, or in exactly the same order as illustrated and described.

Meanings of technical and scientific terms used herein are to be commonly understood as by one of ordinary skill in the art to which the invention belongs, unless otherwise defined.

While the invention has been described with respect to a limited number of embodiments, these should not be construed as limitations on the scope of the invention, but rather as exemplifications of some of the preferred embodiments. Other possible variations, modifications, and applications are also within the scope of the invention. Accordingly, the scope of the invention should not be limited by what has thus far been described, but by the appended claims and their legal equivalents.

What is claimed is:

1. A method of maintaining balance in electric power systems, the method comprising:
detecting a need for load switch from a source phase to a target phase;
applying a Direct Current (DC) conversion to the target phase, to yield a DC representation of the target phase;
synthesizing the DC representation of the target phase to yield synthesized source phase;
conveying specified amount of load from the source phase to the synthesized source phase;
repeatedly advancing, in each cycle, the phase angle of the synthesized source phase until it breaches the phase of target phase, wherein the advancing is carried out in a rate of up to a standard error deviation that complies with electricity standard; and
conveying a load from the synthesized target phase to the target phase.

2. The method according to claim 1, further comprising dividing low voltage neighborhoods areas into a plurality of clusters, and apply the maintaining of balance in electric power in each of the plurality of clusters.
